(19) United States
(12) Patent Application Publication
(10) Pub. No.: US 2024/0384586 A1
(43) Pub. Date: Nov. 21, 2024

(54) LID OPENING AND CLOSING DEVICE

(71) Applicant: U-SHIN LTD., Nagano (JP)

(72) Inventor: Yuki TANAKA, Hiroshima (JP)

(21) Appl. No.: 18/690,832

(22) PCT Filed: Mar. 29, 2022
(86) PCT No.: PCT/JP2022/015661

§ 371 Date: Mar. 11, 2024

(30) Foreign Application Priority Data
Sep. 24, 2021 (JP) 2021-155986

(51) Int. Cl. E05F 15/63; B60L 53/16; E05B 83/34

(52) U.S. Cl. CPC E05F 15/63; E05B 83/34; B60L 53/16; E05Y 2201/71; E05Y 2900/534

(57) ABSTRACT

A lid opening and closing device includes a base including a bearing portion, a receiving portion attached to the base, a lid that closes the opening portion, an arm having a pivot portion pivotally supported by the bearing portion and a distal end portion connected to the lid, a first gear that transmits a drive force received from a drive source to the pivot portion of the arm to rotate, a second gear rotating in conjunction with the first gear, a lock member movable by a cam of the second gear, an engaging portion provided on the arm and with which the lock member engages, and a differential mechanism starting rotation of the pivot portion with a delay to start of rotation of the first gear when the arm at a retracted position is moved to an advanced position.

### DESCRIPTION

### Technical Field

The present invention relates to a lid opening and closing device.

### Background Art

Patent Documents 1 and 2 disclose a lid opening and closing device used for an electric automobile. The lid opening and closing device of Patent Document 1 includes a motor for automatically opening and closing a lid. The lid opening and closing device of Patent Document 2 includes a lock mechanism including an actuator for advancing and retracting a lock pin for locking the lid in a closed state.

### PRIOR ART DOCUMENTS

### Patent Documents

Patent Document 1: JP-A-2014-210473

Patent Document 2: JP-A-2011-240753

### SUMMARY OF THE INVENTION

### Problems to be Solved by the Invention

In the lid opening and closing device of Patent Document 1, since the lid in the closed state cannot be locked in an unreleasable manner, there is room for improvement in security. By applying the lock mechanism of Patent Document 2 to the lid opening and closing device of Patent Document 1, security can be improved. In this case, two drive sources for opening and closing the lid and for locking the lid are required, and thus the lid opening and closing device becomes large in size.

An object of the present invention is to suppress an increase in size of a lid opening and closing device and to realize automatic opening and closing and locking of a lid.

### Solutions to the Problems

The present invention provides a lid opening and closing device including: a base including a bearing portion and arranged inside an opening portion of a panel; a receiving portion attached to the base so as to be located in the opening portion; a lid that openably closes the opening portion; an arm including a pivot portion on one end side pivotally supported by the bearing portion and a distal end portion on the other end side connected to the lid, the arm being movable between a retracted position where the arm is retracted into the panel and the opening portion is closed by the lid, and an advanced position where the arm is protruded to an outside of the panel and the opening portion is opened; a first gear that transmits a drive force received from a drive source to the pivot portion to rotate the pivot portion; a second gear that includes a cam and rotates in conjunction with the first gear; a lock member that is movable between a lock position and an unlock position by the cam when the arm is at the retracted position; an engaging portion provided on the arm and capable of engaging with the lock member when the arm is at the retracted position; and a differential mechanism provided in the pivot portion and the first gear, the differential mechanism being configured to start rotation of the pivot portion with a delay with respect to start of rotation of the first gear when the arm at the retracted position is moved to the advanced position.

In the present aspect, since the first gear that transmits the drive force of the drive source to the pivot portion of the arm to rotate is provided, the lid can be automatically opened and closed via the arm. In addition, the second gear that rotates in conjunction with the first gear and the lock member movable by the cam of the second gear are provided, and the lock member engages with the engaging portion of the arm when the arm rotates to the retracted position, so that the lid can be locked via the arm. As described above, since the automatic opening and closing of the lid and the locking of the lid by the lock member can be realized by one drive source, security can be improved while suppressing an increase in size and cost of the lid opening and closing device as compared with the case of mounting two drive sources.

### Effects of the Invention

In the present invention, an increase in size of the lid opening and closing device can be suppressed, and automatic opening and closing and locking of the lid can be realized.

### BRIEF DESCRIPTION OF THE DRAWINGS

FIG. 1 is a perspective view of a lid opening and closing device according to an embodiment of the present invention.

FIG. 2 is a cross-sectional view taken along line II-II of FIG. 1.

FIG. 3 is a cross-sectional view of the lid opening and closing device with a lid closed, similar to FIG. 2.

FIG. 4 is an exploded perspective view of the lid opening and closing device as viewed from the back side.

FIG. 5 is an exploded perspective view of a bearing portion in FIG. 4.

FIG. 6 is an exploded perspective view in which a base of FIG. 5 is represented by an imaginary line.

FIG. 7 is a cross-sectional view taken along line VII-VII of FIG. 3.

FIG. 8 is a cross-sectional view taken along line VIII-VIII of FIG. 3.

FIG. 9 is a perspective view showing a lid, a lock member, and a drive mechanism thereof.

FIG. 10 is a cross-sectional view taken along line X-X of FIG. 9.

FIG. 11 is a bottom view showing a relationship between an arm and a drive mechanism.

FIG. 12A is a graph showing movements of the arm and the lock member during an opening operation of the lid.

FIG. 12B is a graph showing movements of the arm and the lock member at the time of a closing operation of the lid.

FIG. 13A is a perspective view showing the lock member and the drive mechanism in a first process at the time of a lid opening operation.

FIG. 13B is a cross-sectional view similar to FIG. 10 in the state of FIG. 13A.

FIG. 14A is a perspective view showing the lock member and the drive mechanism in a second process at the time of the lid opening operation.

FIG. 14B is a cross-sectional view similar to FIG. 10 in the state of FIG. 14A.

FIG. 15A is a perspective view showing a lock member and a drive mechanism in a lid open state.

FIG. 15B is a cross-sectional view similar to FIG. 10 in the state of FIG. 15A.

FIG. 16A is a perspective view showing the lock member and the drive mechanism in the first process at the time of a lid closing operation.

FIG. 16B is a cross-sectional view similar to FIG. 10 in the state of FIG. 16A.

FIG. 17A is a perspective view showing the lock member and the drive mechanism in the second process at the time of the lid closing operation.

FIG. 17B is a cross-sectional view similar to FIG. 10 in the state of FIG. 17A.

FIG. 18A is a perspective view showing the lock member and the drive mechanism in a third process at the time of the lid closing operation.

FIG. 18B is a cross-sectional view similar to FIG. 10 in the state of FIG. 18A.

### DETAILED DESCRIPTION

Hereinafter, an embodiment of the present invention will be described with reference to the accompanying drawings.

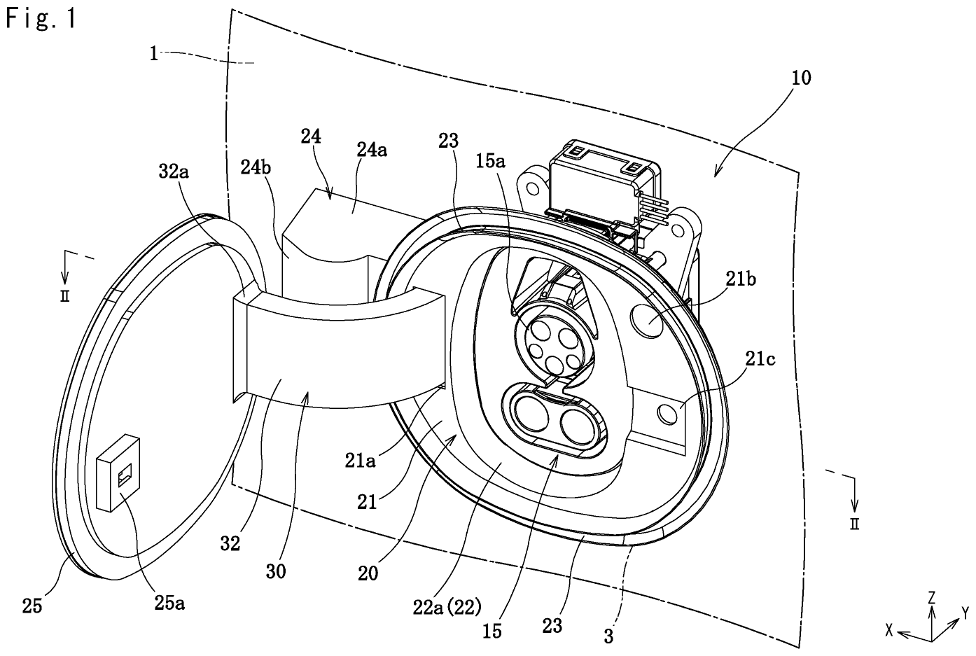

FIG. 1 shows a lid opening and closing device 10 according to an embodiment of the present invention. The lid opening and closing device 10 includes a power supply connector 15 to which a charging plug (not shown) is connected, and is attached to a side panel (panel) 1 of the automobile. The power supply connector 15 is a receiving portion for supplying electricity. However, the receiving portion may be configured to be replenished with any of liquid fuel such as gasoline and light oil, and gaseous fuel such as hydrogen and LP gas instead of the power supply connector 15.

An X direction described in each drawing cited in the following description is an automobile length direction of the automobile, a Y direction is an automobile width direction of the automobile, and a Z direction is an automobile height direction of the automobile. In each drawing, the direction indicated by the arrow in the X direction is the front side, and the direction opposite to the arrow is the rear side. The direction indicated by the arrow in the Y direction is a vehicle interior side (inner side), and the direction opposite to the arrow is a vehicle exterior side (outer side). The direction indicated by the arrow in the Z direction is the upper side, and the direction opposite to the arrow is the lower side.

Referring to FIGS. 1 to 3, the side panel 1 is provided with a concave portion 2 recessed inward in the vehicle width direction Y. An outer end of the concave portion 2 in the vehicle width direction Y is an opening portion 3. An attachment port 4 for attaching the lid opening and closing device 10 is provided at the bottom of the concave portion 2. The shapes of the opening portion 3 and the attachment port 4 as viewed in the vehicle width direction Y are substantially elliptical in the present embodiment, but can be changed as necessary.

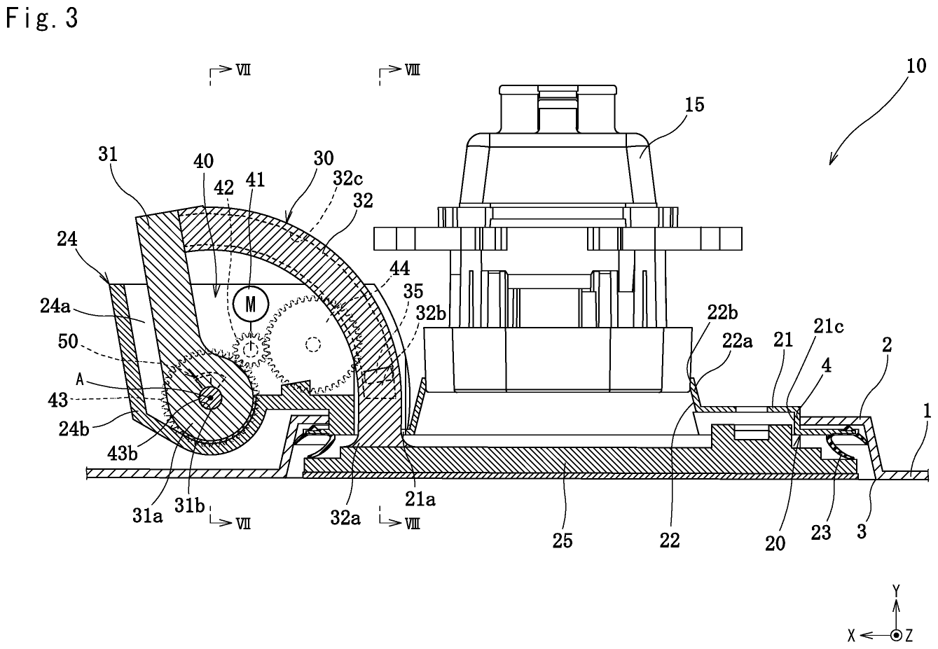

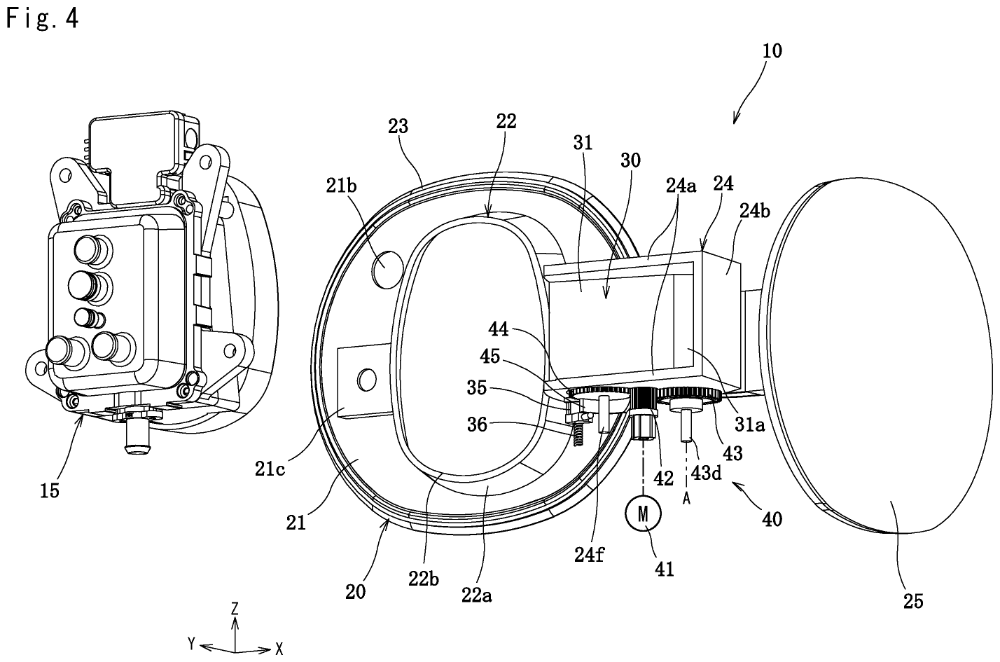

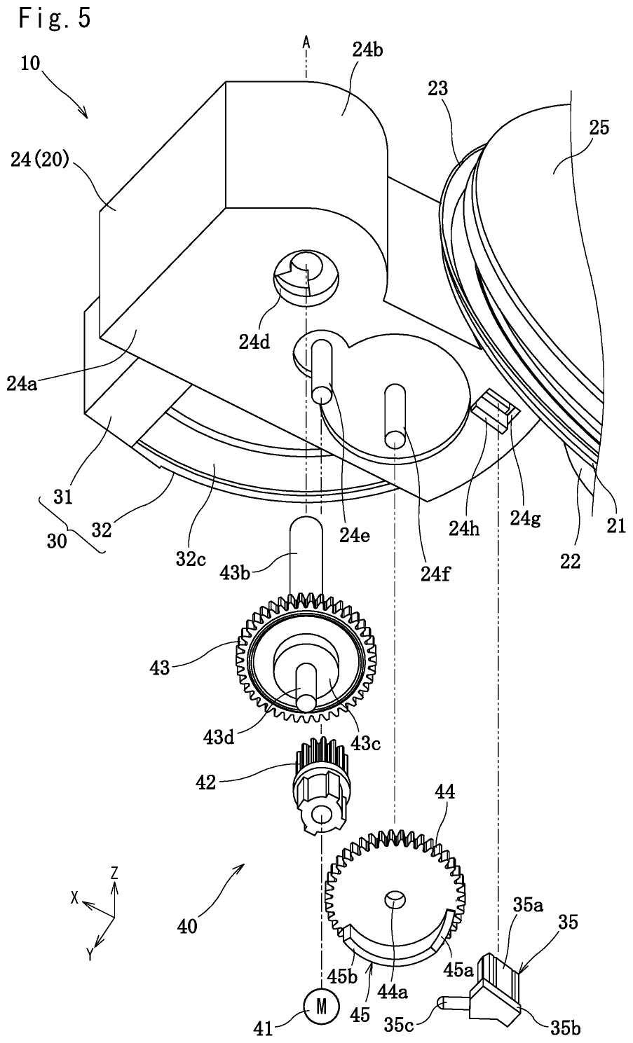

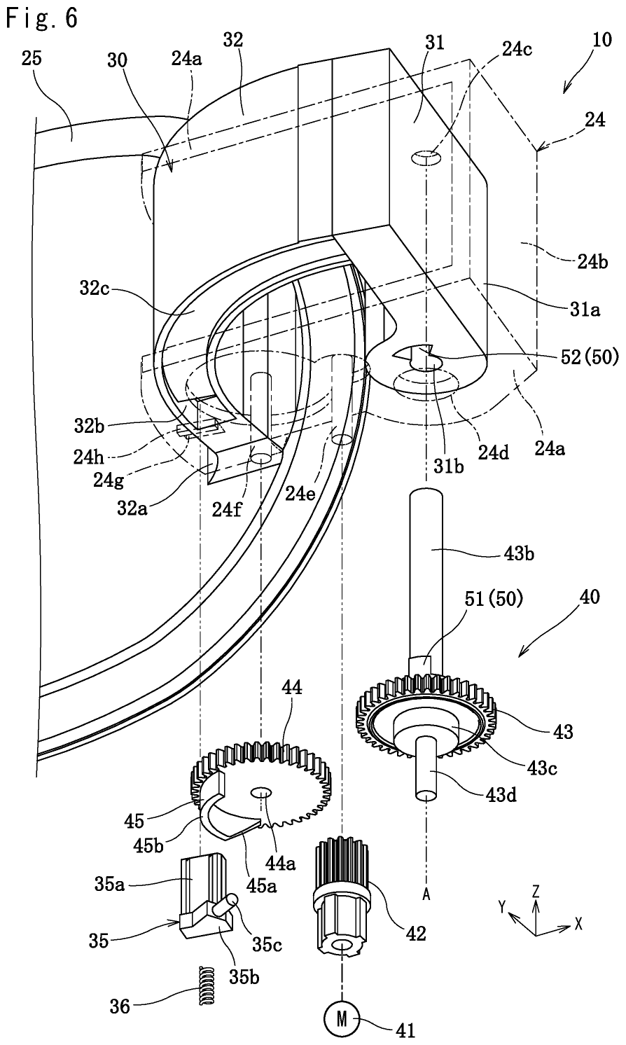

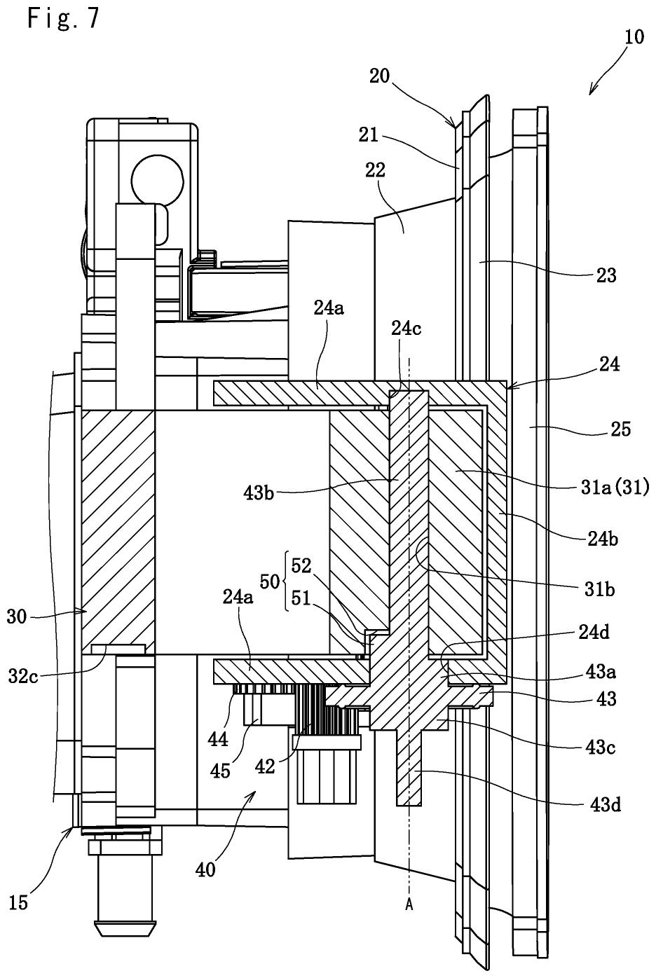

Subsequently, referring to FIGS. 1 to 3, the lid opening and closing device 10 includes a base 20 attached to the side panel 1, a lid 25 for closing the opening portion 3, and an arm 30 having one end side pivotally supported by the base 20 and the other end side to which the lid 25 is attached. Referring to FIGS. 4 and 5, the lid opening and closing device 10 of the present embodiment includes a lock member 35 that locks the arm 30 in a state where the lid 25 is located at the closed position shown in FIG. 3, and a drive mechanism 40 that moves the arm 30 (lid 25) and the lock member 35. Furthermore, referring to FIGS. 6 and 7, a differential mechanism 50 that secures a time difference between the start of rotation of the arm 30 and the start of movement of the lock member 35 is provided at a coupling portion between the drive mechanism 40 and the arm 30.

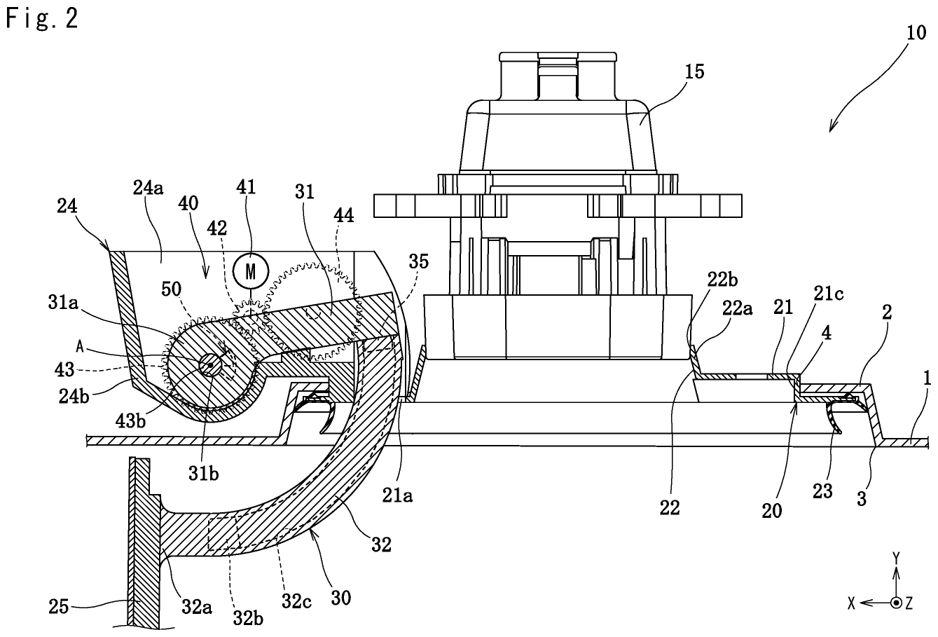

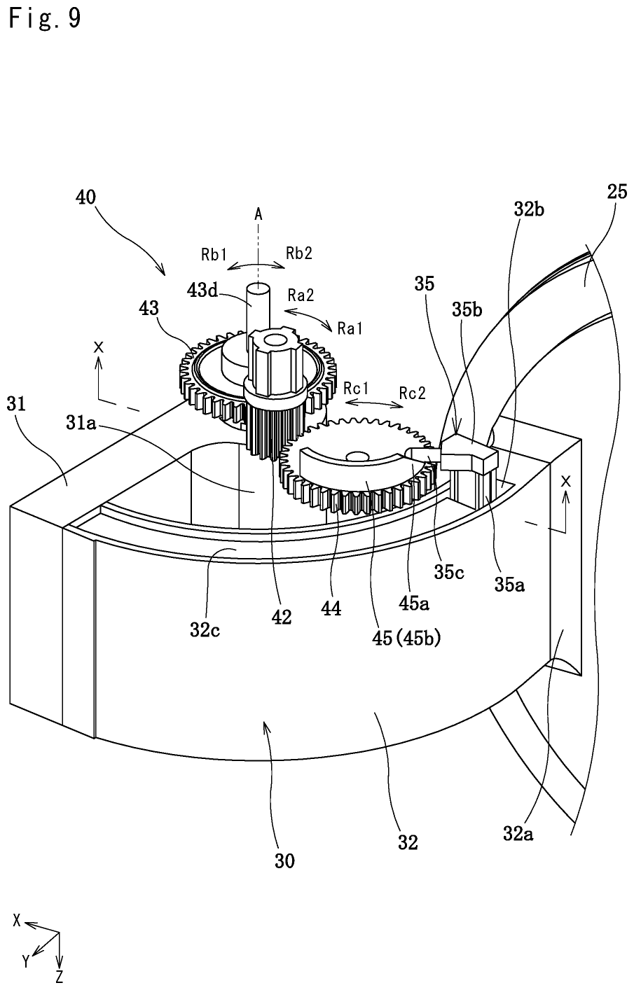

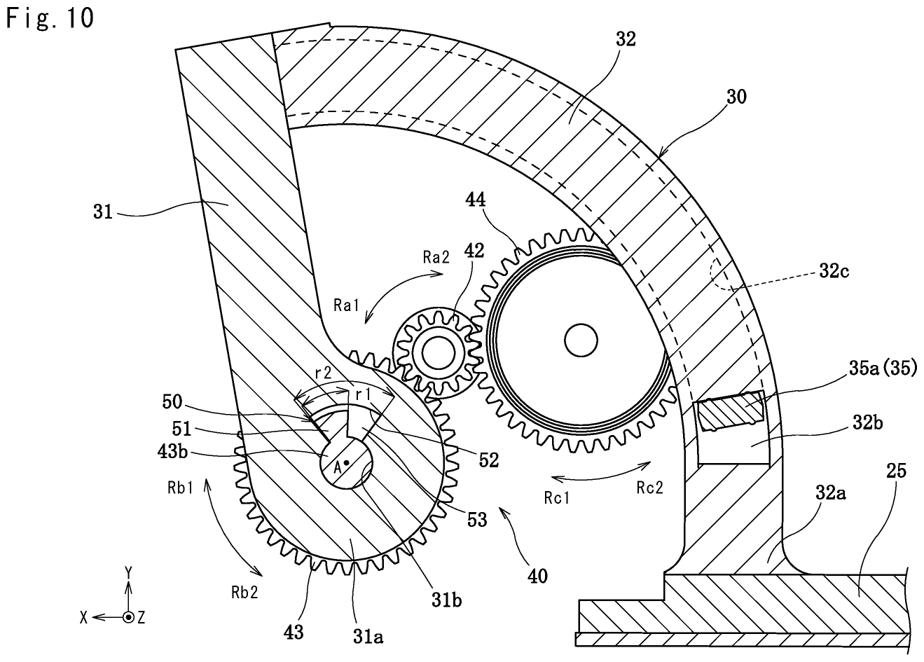

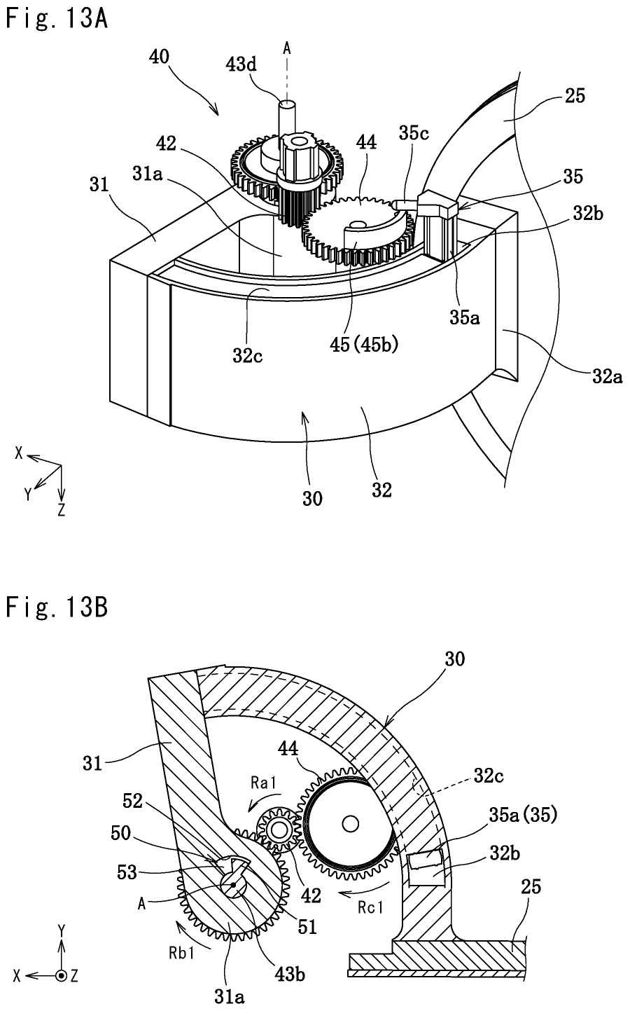

The arm 30 is rotated by the drive mechanism 40 between an advanced position protruding to the outside of the side panel 1 as shown in FIG. 2 and a retracted position retracted into the side panel 1 as shown in FIG. 3. The lid 25 takes a posture (open position) in which the opening portion 3 is opened when the arm 30 is rotated to the advanced position as shown in FIG. 2, and takes a posture (closed position) in which the opening portion 3 is closed when the arm 30 is rotated to the retracted position as shown in FIG. 3. In addition, the lock member 35 linearly moves (moves) between a lock position shown in FIGS. 9 and 10 and an unlock position shown in FIGS. 13A and 13B by the drive mechanism 40. The differential mechanism 50 starts the rotation of the arm 30 with a delay with respect to the start of the movement of the lock member 35.

In the following description, the rotation of the lid 25 accompanying the rotation of the arm 30 by the drive mechanism 40 may be simply referred to as the rotation of the lid 25 by the drive mechanism 40. The locking or unlocking of the arm 30 by the lock member 35 may be referred to as locking or unlocking of the lid 25 by the lock member 35.

Hereinafter, the base 20, the lid 25, the arm 30, the lock member 35, the drive mechanism 40, and the differential mechanism 50 will be specifically described.

Referring to FIGS. 1 and 4, the base 20 includes a base body 21 that closes the attachment port 4 (see FIGS. 2 and 3), and a bearing portion 24 that pivotally supports the arm 30.

The base body 21 is provided with an attachment portion 22 for attaching the power supply connector 15, and a seal member 23 for sealing between the lid 25 at the closed position and the base body 21 is attached.

Referring to FIG. 4, the attachment portion 22 includes a concave portion 22a recessed inward in the vehicle width direction Y, and an attachment port 22b is formed at the bottom of the concave portion 22a. A power supply connector 15 is attached to the attachment port 22b from the inside in the vehicle width direction Y. Thus, as shown in FIG. 1, a connecting portion 15a of the power supply connector 15 is located in the opening portion 3, and is exposed to the outside of the vehicle through the opening portion 3 when the lid 25 is released.

Referring to FIGS. 2 and 3, the seal member 23 has a ring shape, is attached to the outer side of the base body 21 in the vehicle width direction Y along the outer peripheral edge of the base body 21, and protrudes from the bottom side of the concave portion 2 toward the opening portion 3. The seal member 23 is brought into pressure contact with the lid 25 at the closed position shown in FIG. 3, and seals a space between the base body 21 and the lid 25 in a watertight manner. The seal member 23 is not brought into pressure contact with the lid 25 at the open position shown in FIG. 2.

Referring to FIGS. 1, 2, and 4, the base body 21 is further provided with an insertion through hole 21a, a window through hole 21b, and a concave portion 21c so as to be located in the opening portion 3.

The insertion through hole 21a is a quadrangular hole having a long dimension in the vehicle height direction Z, and is provided so as to be located on the front side of the attachment portion 22 in the vehicle length direction X and in the bearing portion 24. The arm 30 is inserted through the insertion through hole 21a so as to be movable forward and backward.

The window through hole 21b is formed of a circular hole and is provided on the rear side in the vehicle length direction X of the attachment portion 22. The window through hole 21b exposes an operation unit of a switch (not shown) when the lid 25 is released.

The concave portion 21c is a quadrangular recess and is provided below the window through hole 21b. The concave portion 21c communicates with the inside of the concave portion 22a of the attachment portion 22.

Referring to FIGS. 4 and 5, the bearing portion 24 has an integral structure with the base body 21, is adjacent to the front side of the attachment portion 22 in the vehicle length direction X, and protrudes outward from the base body 21. The bearing portion 24 includes a pair of end plates 24a and a coupling plate 24b coupling the end plates 24a. The pair of end plates 24a are provided at intervals in the vehicle height direction Z so as to be located above and below the insertion through hole 21a, and both extend along the XY plane. The coupling plate 24b is continuous with the front end in the vehicle length direction X and the outer end in the vehicle width direction Y of each of the pair of end plates 24a, and opens the other end of the end plate 24a.

Referring to FIGS. 5 and 7, the upper end plate 24a is provided with a shaft hole 24c, and the lower end plate 24a is provided with a through hole 24d at a position facing the shaft hole 24c. A center line in the vehicle height direction Z passing through the shaft hole 24c and the through hole 24d is the rotation axis A. Shaft portions 24e and 24f that rotatably attach a drive gear 42 and a second gear 44, which will be described later and are included in the drive mechanism 40, protrude downward in the vehicle height direction Z on the attachment portion 22 side of the through hole 24d in the lower end plate 24a. The axis of each of the shaft portions 24e and 24f is located in parallel with the rotation axis A.

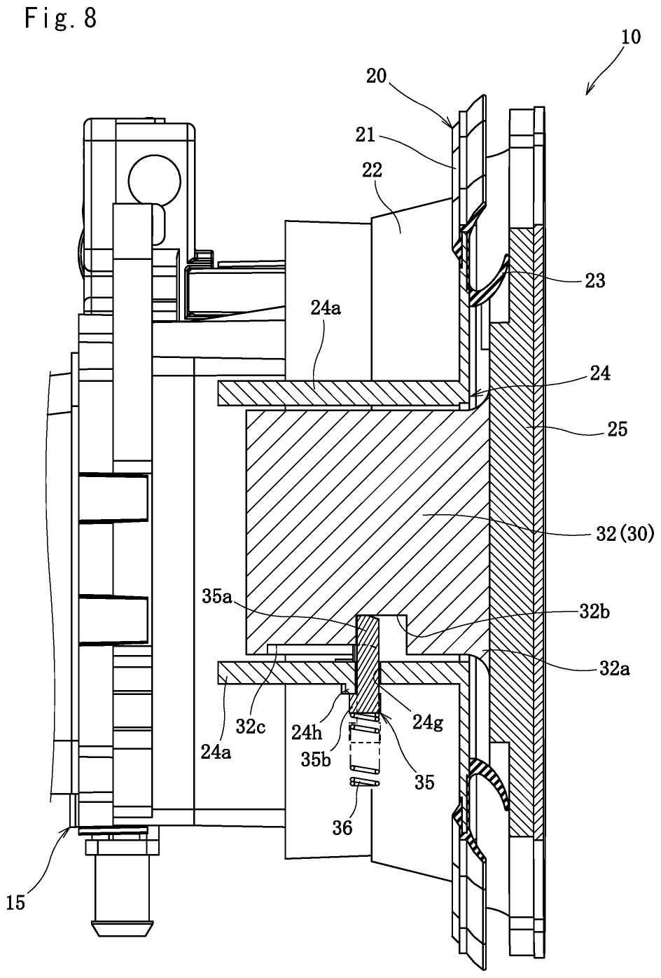

Referring to FIGS. 5 and 8, the lower end plate 24a is further provided with an insertion through hole 24g through which the lock member 35 is inserted so as to be movable forward and backward on the attachment portion 22 side of the shaft portion 24f. A plate-shaped stopper portion 24h protruding downward is provided at a hole edge of the insertion through hole 24g.

Referring to FIGS. 1 and 3, the lid 25 has a plate shape smaller than the opening portion 3 and larger than the seal member 23, and closes the opening portion 3 so as to be openable. The lid 25 is rotatable with respect to the base 20 by being coupled to the arm 30 pivotally supported by the bearing portion 24. The lid 25 is provided with a convex portion 25a that fits into the concave portion 21c of the base 20 when rotated to the closed position shown in FIG. 3.

Referring to FIGS. 1 to 3, the arm 30 is arranged to straddle from the inside to the outside of the base 20 in the vehicle width direction Y through the insertion through hole 21a. The arm 30 includes a plate-shaped first arm portion 31 pivotally supported by the bearing portion 24 and an arc-shaped second arm portion 32 connected to the lid 25.

A pivot portion 31a pivotally supported by the bearing portion 24 is provided at a proximal end (one end side of the arm 30) of the first arm portion 31. That is, the first arm portion 31 protrudes outward from the pivot portion 31a. Referring to FIGS. 6 and 7, the pivot portion 31a includes a shaft through hole 31b, and a shaft portion 43b, which will be described later and are the drive mechanism 40, is inserted therethrough. The pivot portion 31a is arranged between the pair of end plates 24a of the bearing portion 24 and is rotatable around the rotation axis A (shaft portion 43b).

Referring to FIGS. 1 to 3, the second arm portion 32 is mechanically connected to a distal end of the first arm portion 31 on a side opposite to the pivot portion 31a. The second arm portion 32 has an arc shape centered on the rotation axis A. A connecting portion (distal end portion) 32a mechanically connected to the lid 25 is provided at the distal end of the second arm portion 32 (the other end side of the arm 30).

Referring to FIGS. 6 and 8, a lock hole (engaging portion) 32b and a recessed groove 32c are provided on the lower surface of the second arm portion 32.

The lock hole 32b is a quadrangular recess extending upward and is larger than the lock member 35 as viewed in the vehicle height direction Z. The lock hole 32b is located immediately above the insertion through hole 24g of the bearing portion 24 when the arm 30 rotates to the retracted position shown in FIGS. 3 and 9, and allows the movement of the lock member 35 to the lock position. As a result, the lock member 35 engages with the lock hole 32b.

The recessed groove 32c is a recess shallower than the lock hole 32b, and extends in an arc shape from the lock hole 32b to the end of the second arm portion 32 on the first arm portion 31 side. The recessed groove 32c allows sliding contact of the lock member 35.

Referring to FIGS. 5, 6, and 8, the lock member 35 is arranged in the insertion through hole 24g of the bearing portion 24. When the arm 30 is at the retracted position, the lock member 35 is linearly movable between the lock position shown in FIGS. 9 and 10 and the unlock position shown in FIGS. 13A and 13B. The lock member 35 is elastically biased toward the lock position side (upward which is the arm 30 side) by a spring 36 whose one end is supported by a cover (not shown).

Referring to FIGS. 6 and 8, the lock member 35 includes a lock portion 35a movable forward and backward into the lock hole 32b and a head portion 35b located outside the lock hole 32b at both the lock position and the unlock position. A cam follower 35c protrudes from the head portion 35b.

The lock portion 35a is smaller than the lock hole 32b and the recessed groove 32c of the second arm portion 32, and is a block body having a quadrangular cross section that can be inserted into the insertion through hole 24g of the bearing portion 24.

The head portion 35b is a plate body having an outer shape larger than the insertion through hole 24g of the bearing portion 24 as viewed in the vehicle height direction Z. The head portion 35b abuts on the stopper portion 24h of the bearing portion 24 when the lock member 35 moves to the lock position. As a result, further upward movement of the lock member 35 is restricted.

The cam follower 35c is a rod having a circular cross section, and is provided to retract the lock member 35 at the lock position to the unlock position. The cam follower 35c protrudes from the head portion 35b toward the pivot portion 31a (the front side in the vehicle length direction X).

When the cam follower 35c is pressed downward by the drive mechanism 40, the lock member 35 moves from the lock position to the unlock position against the biasing force of the spring 36 (see FIG. 13A). Accordingly, since the engagement of the lock portion 35a and the lock hole 32b is released, the lock member 35 allows the rotation of the arm 30 between the retracted position and the advanced position, that is, the opening and closing of the lid 25.

When the pressing of the cam follower 35c by the drive mechanism 40 is released and the lock hole 32b is located immediately above the lock portion 35a, the lock member 35 moves from the unlock position to the lock position by the biasing force of the spring 36 (see FIG. 9). Accordingly, since the lock portion 35a engages with the lock hole 32b, the lock member 35 prevents (locks) the rotation of the arm 30 from the retracted position to the advanced position, that is, the rotation of the lid 25 at the closed position to the open position.

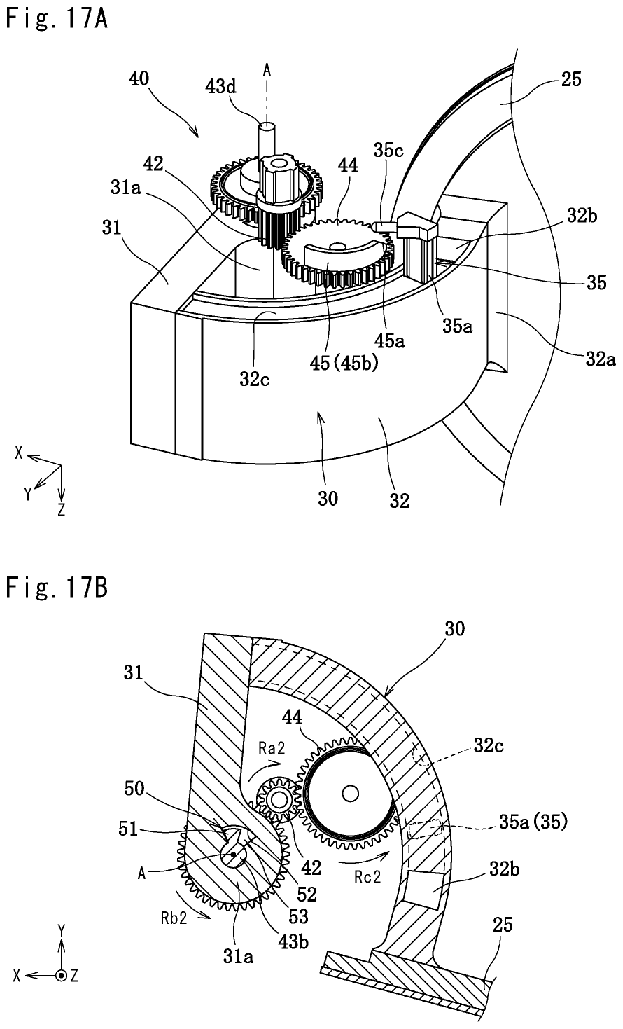

Even if the pressing of the cam follower 35c by the drive mechanism 40 is released, in a case where the lock hole 32b is not located immediately above the lock portion 35a, the lock member 35 abuts on the bottom of the recessed groove 32c by the biasing force of the spring 36, and the movement to the lock position and the engagement with the lock hole 32b are impossible (see FIG. 17A). This state is maintained until the lock hole 32b is located immediately above the lock member 35 by the rotation of the arm 30, and when the lock hole 32b is located immediately above the lock member 35, the lock member 35 moves to the lock position and engages with the lock hole 32b.

Referring to FIGS. 5 and 6, the drive mechanism 40 is arranged below the bearing portion 24 and covered with a cover (not shown). The drive mechanism 40 includes one motor 41, a drive gear 42 attached to the motor 41, a first gear 43 that rotates the pivot portion 31a (arm 30), and a second gear 44 that moves the lock member 35.

The motor 41 is a drive source capable of forward rotation and backward rotation, and performs both opening and closing of the lid 25 and movement of the lock member 35 between the lock position and the unlock position. The motor 41 rotates forward or backward in accordance with a command from an electronic control unit (ECU) electrically connected via a drive circuit. By the forward rotation, the motor 41 actuates the arm 30 at the retracted position to the advanced position, and actuates the lock member 35 at the lock position to the unlock position. By the backward rotation, the motor 41 actuates the arm 30 at the advanced position to the retracted position, and actuates the lock member 35 at the unlock position to the lock position.

The drive gear 42 is rotatably attached to the shaft portion 24e of the bearing portion 24, is attached to the output of the motor 41, and is directly rotated by the motor 41. Referring to FIGS. 9 and 10, when the motor 41 rotates forward, the drive gear 42 rotates in the direction indicated by Ra1, rotates the first gear 43 in the direction indicated by Rb1, and rotates the second gear 44 in the direction indicated by Rc1. On the other hand, when the motor 41 rotates backward, the drive gear 42 rotates in the direction indicated by Ra2, rotates the first gear 43 in the direction indicated by Rb2, and rotates the second gear 44 in the direction indicated by Rc2.

Referring to FIGS. 6, 7, and 10, the first gear 43 is arranged coaxially with the pivot portion 31a of the arm 30 and is meshed with the drive gear 42. The first gear 43 and the pivot portion 31a are coupled via the differential mechanism 50. When the drive force of the motor 41 is transmitted to the first gear 43 via the drive gear 42, the first gear 43 rotates in the direction Rb1 or Rb2. As a result, the pivot portion 31a (arm 30) rotates in the same direction via the differential mechanism 50. The first gear 43 includes a protruding portion 43a and a shaft portion 43b protruding from the upper surface, and a protruding portion 43c and a shaft portion 43d protruding from the lower surface. The protruding portion 43a has a columnar shape and is rotatably fitted into the through hole 24d of the bearing portion 24. The shaft portion 43b protrudes from the protruding portion 43a, passes through the shaft through hole 31b of the arm 30, and is rotatably attached to the shaft hole 24c of the bearing portion 24. The protruding portion 43c has a columnar shape and is rotatably fitted into a through hole of the cover. The shaft portion 43d protrudes from the protruding portion 43c.

Referring to FIGS. 5, 6, and 10, the second gear 44 is arranged between the drive gear 42 (first gear 43) and the second arm portion 32, and is meshed with the drive gear 42. The second gear 44 includes a shaft through hole 44a and is rotatably attached to the shaft portion 24f of the bearing portion 24. The diameter and the number of teeth of the second gear 44 of the present embodiment are the same as the diameter and the number of teeth of the first gear 43. When the drive force of the motor 41 is transmitted to the second gear 44 via the drive gear 42, the second gear 44 rotates in the direction Rc1 or Rc2 in conjunction with the first gear 43.

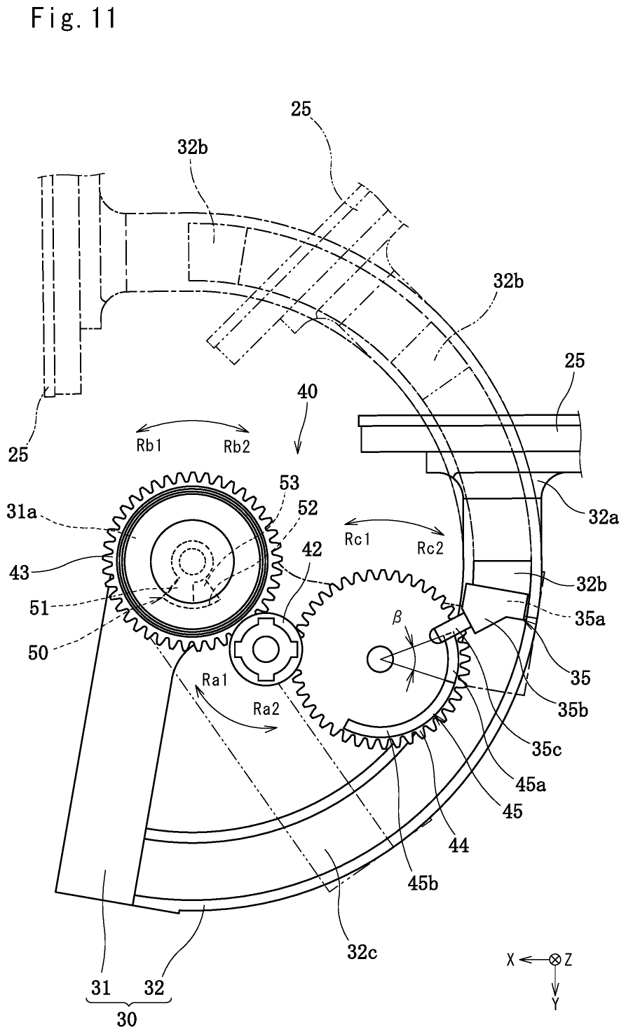

Referring to FIGS. 5 and 11, the second gear 44 is formed of an arc-shaped plate body centered on the shaft through hole 44a, and integrally includes a cam 45 crossing the cam follower 35c of the lock member 35. The cam 45 protrudes from the lower surface of the second gear 44, and the protruding amount of the cam 45 is set to a dimension capable of holding the lock member 35 at the unlock position.

An inclined portion 45a inclined such that the protruding amount gradually increases toward the opposite direction Rc2 is provided at the distal end of the cam 45 in the direction Rc1. By the inclination of the inclined portion 45a, the lock member 35 at the lock position can be moved to the unlock position. The inclined portion 45a has a shape having a linearly extending edge in the present embodiment, but may have a shape having a curved edge as long as the cam follower 35c at the lock position can be moved to the unlock position.

A portion of the cam 45 other than the inclined portion 45a is a holding portion 45b having a uniform protruding amount from the lower surface of the second gear 44, and holds the lock member 35 at the unlock position.

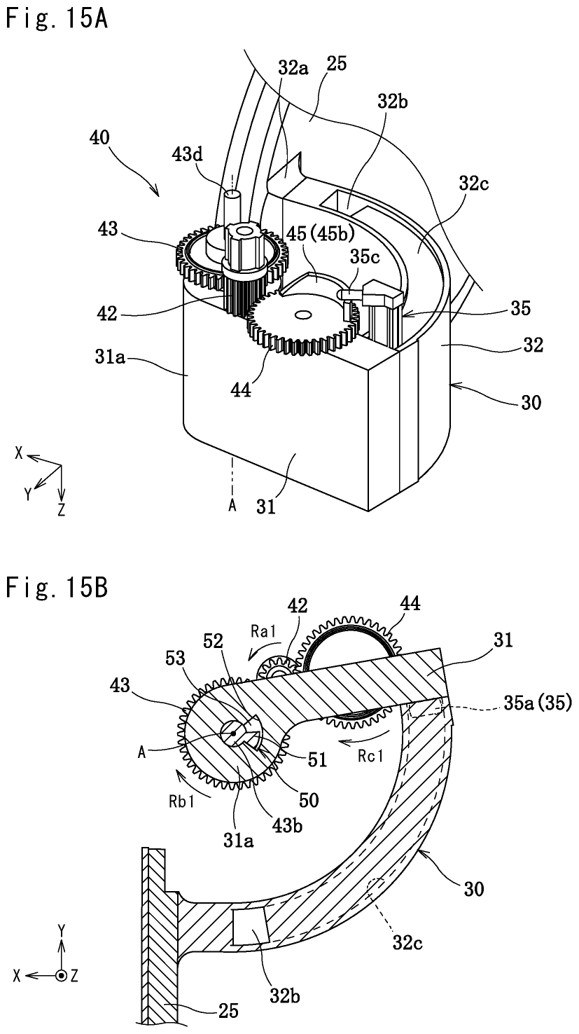

Referring to the portion indicated by a solid line in FIGS. 9 and 11, in a state where the arm 30 is rotated to the retracted position and the lid 25 is rotated to the closed position, the inclined portion 45a of the cam 45 is separated from the cam follower 35c, and the cam follower 35c is arranged in front of the direction Rc1. Referring to the portion indicated by an alternate long and short dash line in FIGS. 15A and 11, an angular range for forming the holding portion 45b of the cam 45 is set so that the cam follower 35c can be held at the unlock position in a state where the arm 30 is rotated to the advanced position and the lid 25 is rotated to the open position.

Referring to FIGS. 6 and 10, the differential mechanism 50 is provided on the first gear 43 and the pivot portion 31a of the arm 30, and starts the rotation of the pivot portion 31a with a delay from the start of the rotation of the first gear 43. Specifically, the differential mechanism 50 includes a convex portion 51 provided on the first gear 43 and a concave portion 52 provided on the pivot portion 31a. However, the convex portion 51 may be provided on the pivot portion 31a, and the concave portion 52 may be provided on the first gear 43.

The convex portion 51 is provided at the base of the shaft portion 43b of the first gear 43. When viewed in the vehicle height direction Z, the convex portion 51 has a fan shape, protrudes upward from the protruding portion 43a, and protrudes radially outward from the shaft portion 43b.

The concave portion 52 is provided on the lower surface of the pivot portion 31a and is formed of a recess extending upward, and the convex portion 51 is arranged inside. When viewed in the vehicle height direction Z, the concave portion 52 has a fan shape larger than the convex portion 51 and spatially communicates with the shaft through hole 31b.

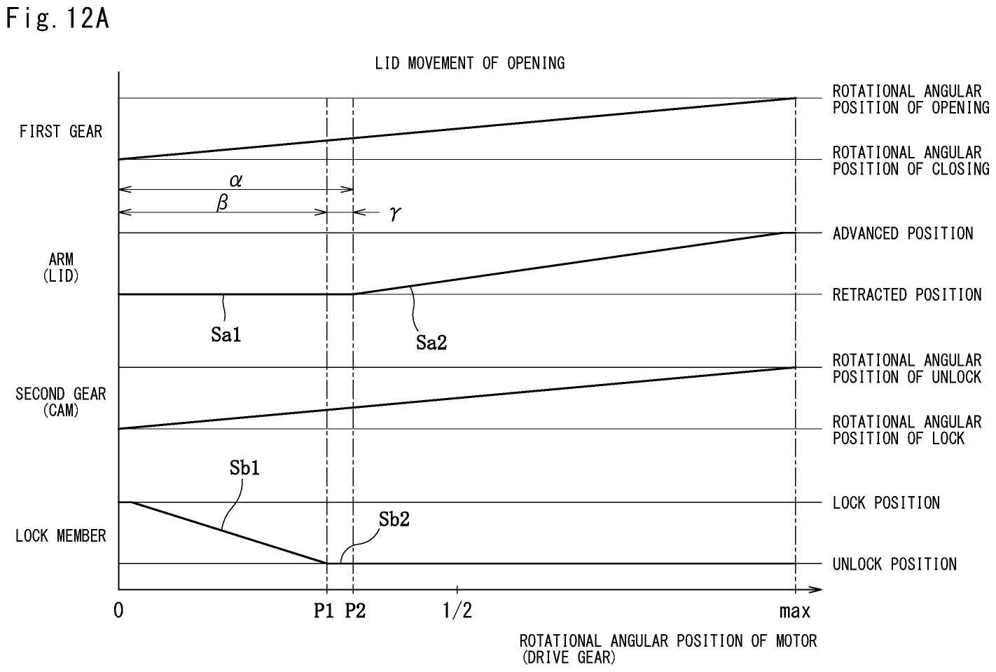

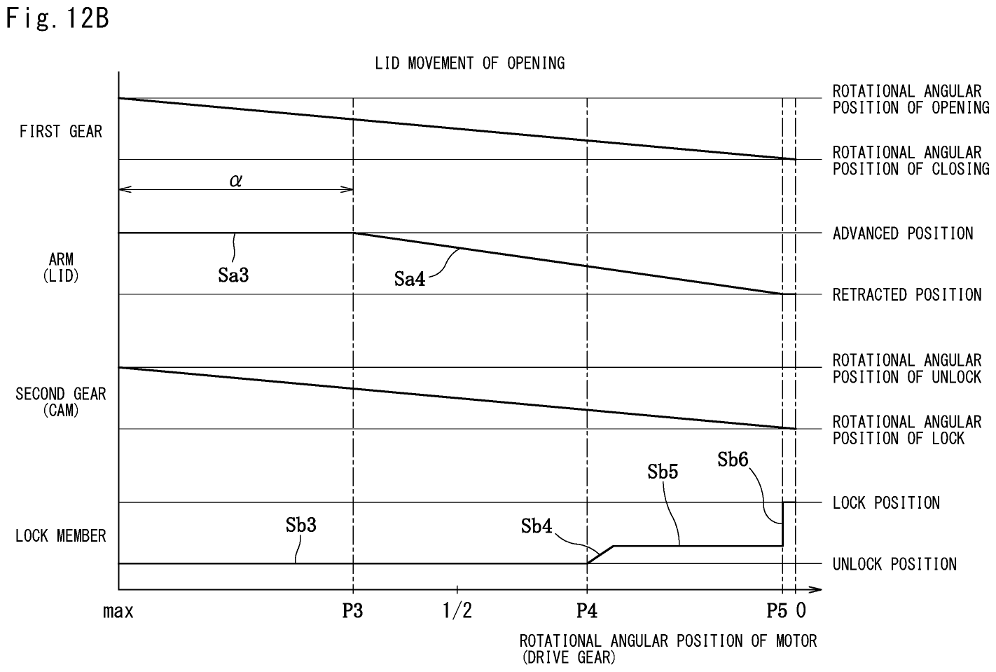

An angular range r1 of the convex portion 51 around the rotation axis A is smaller than an angular range r2 of the concave portion 52 around the rotation axis A. As a result, a gap 53 of a difference between the angular ranges r1 and r2 is formed between the convex portion 51 and the concave portion 52 in the circumferential direction around the rotation axis A. The angular range (r2−r1) of the gap 53 is a differential angular range α (see FIGS. 12A and 12B) that is delayed after the start of rotation of the first gear 43 to rotate the pivot portion 31a.

Referring to FIG. 12A, the differential angular range α is larger than the rotational angular range β of the second gear 44 when the lock member 35 at the lock position is moved to the unlock position by the cam 45. The rotational angular range β corresponds to an angular range for forming the inclined portion 45a (see FIG. 11). When the number of teeth of the first gear 43 and the number of teeth of the second gear 44 are the same, the differential angular range α is larger than the formation angular range β of the inclined portion 45a of the cam 45. When the number of teeth of the first gear 43 is different from the number of teeth of the second gear 44, the angular range of the gap 53 is adjusted according to the gear ratio. As a result, after the lock member 35 at the lock position moves to the unlock position, the opposing surfaces of the convex portion 51 and the concave portion 52 abut on each other, and the rotational force of the first gear 43 can be transmitted to the pivot portion 31a (delay angular range γ). As a result, after the lock member 35 at the lock position moves to the unlock position by the rotation of the cam 45 accompanying the rotation of the second gear 44 from the lock rotational position to the unlock rotational position (direction Rc1), the rotation of the pivot portion 31a can be started such that the arm 30 at the retracted position moves toward the advanced position.

FIG. 11 is a bottom view showing the arrangement of the arm 30, the lock member 35, the drive gear 42, the first gear 43, the second gear 44, and the differential mechanism 50. FIGS. 12A and 12B are graphs showing the movements of the arm 30 and the lock member 35 with respect to the rotational angular position of the motor 41 (drive gear 42). FIG. 12A shows a time of a lid opening operation of rotating the lid 25 at the closed position to the open position, and FIG. 12B shows a time of a lid closing operation of rotating the lid 25 at the open position to the closed position.

Referring to FIG. 11, the formation position of the lock hole 32b of the arm 30 with respect to the lock member 35, the angular range of the cam 45 (the inclined portion 45a and the holding portion 45b) formed in the second gear 44, and the angular range of the gap 53 of the differential mechanism 50 are set so that the lid opening operation shown in FIG. 12A and the lid closing operation shown in FIG. 12B are satisfied.

Specifically, referring to FIGS. 11 and 12A, when the motor 41 rotates forward with the arm 30 at the retracted position, the drive gear 42 rotates in the direction Ra1 from an initial rotational angular position (0) toward a maximum rotational angular position (max). In conjunction with the rotation of the drive gear 42, the first gear 43 starts to rotate in the direction Rb1 from the closed rotational angular position toward the open rotational angular position, and the second gear 44 starts to rotate in the direction Rc1 from a lock rotational angular position toward an unlock rotational angular position. At this time, since the rotational force is not transmitted to the pivot portion 31a due to the presence of the gap 53 of the differential mechanism 50, the arm 30 does not rotate as indicated by Sa1 in FIG. 12A. In addition, since the inclined portion 45a of the cam 45 immediately abuts on the cam follower 35c and presses the cam follower 35c, the lock member 35 at the lock position starts to move to the unlock position as indicated by Sb1 in FIG. 12A. The closed rotational angular position described above means the posture of the first gear 43 in a state where the arm 30 is moved to the retracted position as indicated by a solid line in FIG. 11, and the open rotational angular position means the posture of the first gear 43 in a state where the arm 30 is moved to the advanced position as indicated by a one-dot chain line in FIG. 11. As indicated by a solid line in FIG. 11, the lock rotational angular position means a posture of the second gear 44 in a state where the cam follower 35c is located ahead of the direction Rc1 of the inclined portion 45a of the cam 45 and the movement of the lock member 35 to the lock position is allowed, and the unlock rotational angular position means a posture of the second gear 44 in a state where the cam follower 35c is located at an end of the holding portion 45b of the cam 45 on a side opposite to the inclined portion 45a and the movement of the lock member 35 to the lock position is prevented, as shown in FIG. 15A.

Subsequently, when the drive gear 42 rotates beyond the angular position indicated by P1 in FIG. 12A, the second gear 44 rotates from the lock rotational angular position by an angle or more corresponding to the angular range β in which the inclined portion 45a of the cam 45 is formed. Thus, the cam follower 35c passes through the top of the inclined portion 45a and is located at the holding portion 45b, and the lock member 35 is held at the unlock position (see Sb2 in FIG. 12A). Thereafter, when the drive gear 42 rotates beyond the angular position indicated by P2 in FIG. 12A, the first gear 43 rotates from the closed rotational angular position by an angle or more corresponding to the differential angular range α obtained by adding the delay angular range γ to the formation angular range β of the inclined portion 45a. Therefore, the rotational force of the first gear 43 is transmitted to the pivot portion 31a, and the arm 30 at the retracted position starts to move toward the advanced position (see Sa2 in FIG. 12A).

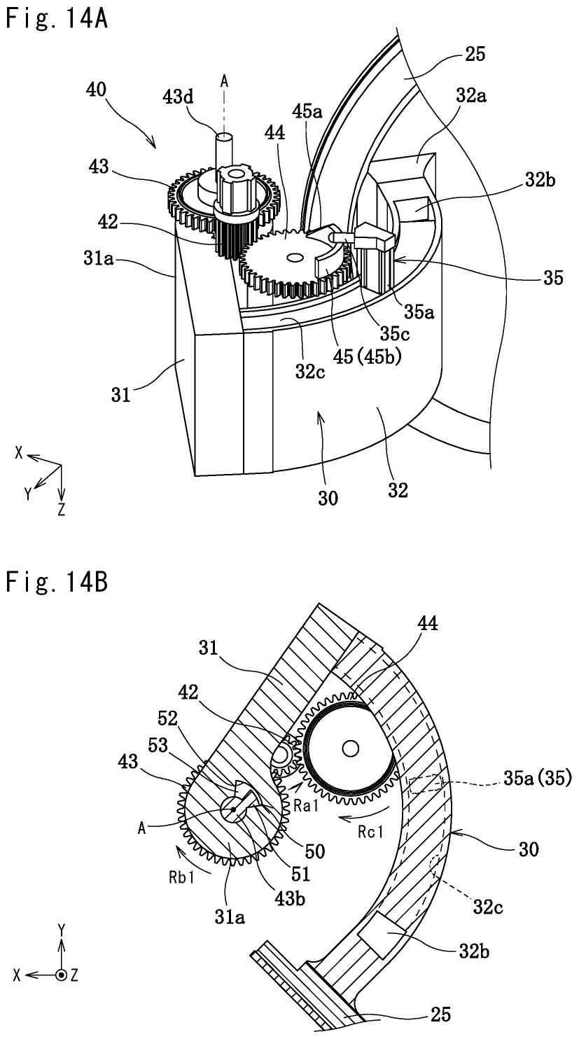

Thereafter, when the drive gear 42 rotates to the maximum rotational angular position (max), the first gear 43 rotates to the open rotational angular position, and the second gear 44 rotates to the unlock rotational angular position. As a result, the arm 30 passes through an intermediate position indicated by a two-dot chain line in FIG. 11 and moves to the advanced position indicated by a one-dot chain line in FIG. 11. Further, since the upward movement of the cam follower 35c continues to be prevented by the holding portion 45b of the cam 45, the lock member 35 is held at the unlock position (see FIGS. 14A and 15A).

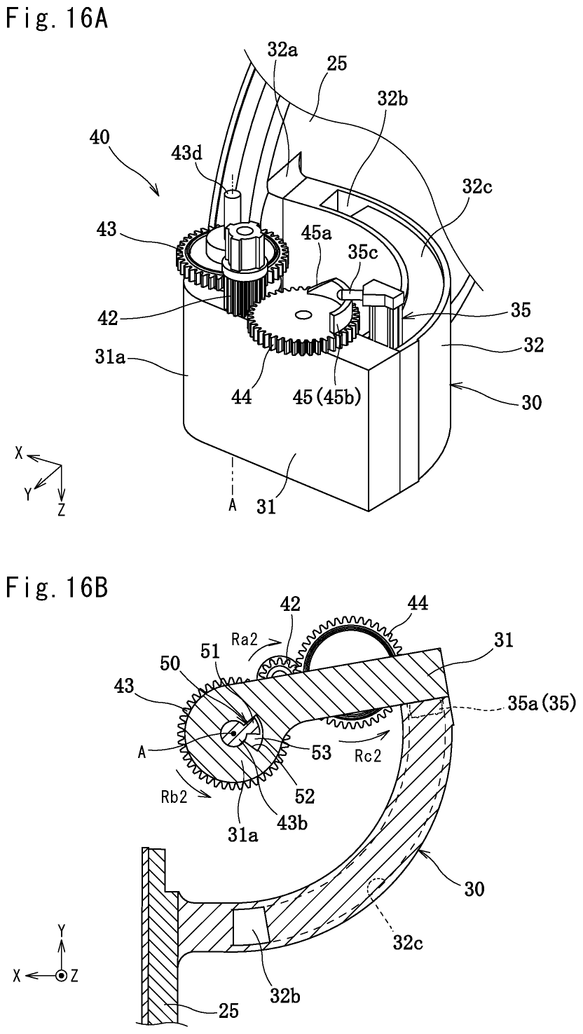

Referring to FIGS. 11 and 12B, when the motor 41 rotates backward with the arm 30 at the advanced position, the drive gear 42 rotates in the direction Ra2 from the maximum rotational angular position (max) toward the initial rotational angular position (0). In conjunction with the rotation of the drive gear 42, the first gear 43 starts to rotate in the direction Rb2 from the open rotational angular position toward the closed rotational angular position, and the second gear 44 starts to rotate in the direction Rc2 from the unlock rotational angular position toward the lock rotational angular position. At this time, since the rotational force is not transmitted to the pivot portion 31a due to the presence of the gap 53 of the differential mechanism 50, the arm 30 does not rotate as indicated by Sa3 in FIG. 12B. Further, since the upward movement of the cam follower 35c is prevented by the holding portion 45b of the cam 45, the lock member 35 is held at the unlock position as indicated by Sb3 in FIG. 12B (see FIG. 16A).

Subsequently, when the drive gear 42 rotates beyond the angular position indicated by P3 in FIG. 12B, the first gear 43 rotates from the open rotational angular position by an angle corresponding to the differential angular range α or more. Therefore, the rotational force of the first gear 43 is transmitted to the pivot portion 31a, and the arm 30 at the advanced position starts to move toward the retracted position (see Sa4 in FIG. 12B). Even in this state, since the upward movement of the cam follower 35c is prevented by the holding portion 45b of the cam 45, the lock member 35 is held at the unlock position (see Sb3 in FIG. 12B).

Subsequently, by the rotation of the first gear 43, the arm 30 continues to move toward the retracted position indicated by the solid line in FIG. 11 through the intermediate position indicated by the two-dot chain line in FIG. 11. When the drive gear 42 rotates beyond the angular position indicated by P4 in FIG. 12B, the cam follower 35c passes through the end portion of the holding portion 45b by the interlocking rotation of the second gear 44. As a result, as indicated by Sb4 in FIG. 12B, the lock member 35 at the unlock position starts to move toward the lock position according to the inclination of the inclined portion 45a by the biasing force of the spring 36 (see FIG. 6). However, at this rotational angular position, the arm 30 does not move to the retracted position, and the lock hole 32b is not located immediately above the lock member 35. Therefore, the movement of the lock member 35 toward the lock position is stopped in a state where the lock portion 35a abuts on the recessed groove 32c of the arm 30 as indicated by Sb5 in FIG. 12B (see FIG. 17A). As a result, the rotation of the second gear 44 causes the cam follower 35c to be separated from the inclined portion 45a of the cam 45.

Thereafter, when the drive gear 42 rotates beyond the angular position indicated by P5 in FIG. 12B, the arm 30 moves to the retracted position by the rotation of the first gear 43 in conjunction therewith. As a result, the lock hole 32b is located immediately above the lock member 35. As a result, the lock member 35 released from the abutment on the recessed groove 32c moves to the lock position by the biasing force of the spring 36 (see FIG. 6) as indicated by Sb6 in FIG. 12B, and engages with the lock hole 32b (see FIGS. 9 and 10).

As described above, by setting the formation position of the lock hole 32b, the formation angular range of the entire cam 45, the differential angular range α by the gap 53, the formation angular range β of the inclined portion 45a, and the delay angular range γ so that the lid opening operation shown in FIG. 12A and the lid closing operation shown in FIG. 12B are satisfied, the locking and unlocking of the arm 30 (lid 25) by the lock member 35 can be realized by one motor 41 without hindering the movement of the arm 30 between the advanced position shown in FIG. 2 and the retracted position shown in FIG. 3.

Next, the operation of the lid opening and closing device 10 configured as described above will be described.

First, as shown in FIGS. 9 and 10, in a state where the arm 30 rotates to the retracted position and the lid 25 rotates to the closed position, the lock member 35 engages with the lock hole 32b of the arm 30. Referring to FIG. 9, the cam 45 is separated from the cam follower 35c of the lock member 35, and referring to FIG. 10, the convex portion 51 of the differential mechanism 50 is located on the left side (direction Rb2 side) in the concave portion 52.

In this closed state, when an opening switch (not shown) provided in the vehicle or an opening switch (not shown) of an electronic key is operated, the motor 41 rotates forward. As a result, the drive gear 42 rotates in the direction Ra1, the first gear 43 starts to rotate in the direction Rb1, and the second gear 44 starts to rotate in the direction Rc1.

As shown in FIG. 13A, when the second gear 44 rotates, the cam 45 rotates integrally, the inclined portion 45a presses the cam follower 35c downward (upward in FIG. 13A), and the lock member 35 at the lock position moves to the unlock position. As a result, the engagement between the lock member 35 and the lock hole 32b is released. As shown in FIG. 13B, when the first gear 43 rotates, the convex portion 51 of the differential mechanism 50 rotates integrally, and the convex portion 51 moves to the right side (direction Rb1 side) in the concave portion 52. During this time, since the convex portion 51 merely moves in the gap 53 and does not press the opposing surface of the concave portion 52, the pivot portion 31a of the arm 30 does not rotate.

Next, as shown in FIGS. 14A and 14B, the pressing of the opposing surface of the concave portion 52 by the convex portion 51 is started by the rotation of the first gear 43, and the arm 30 at the retracted position starts to rotate toward the advanced position. Thus, the lid 25 at the closed position starts to rotate toward the open position. At this time, since the lock member 35 is held at the unlock position by the holding portion 45b of the cam 45 so as to be located in the recessed groove 32c, the rotation of the arm 30 is not hindered.

Subsequently, as shown in FIGS. 15A and 15B, when the arm 30 rotates to the advanced position via the differential mechanism 50 by the rotation of the first gear 43, the motor 41 stops. In this state, the lock member 35 is held at the unlock position by the holding portion 45b of the cam 45, and is located at the end of the recessed groove 32c on the first arm portion 31 side. As shown in FIGS. 1 and 2, the lid 25 is rotated to the open position, and the opening portion 3 is opened to expose the power supply connector 15 to the outside.

When any one of a switch (not shown) attached to the base 20, a closing switch (not shown) provided in the vehicle, and a closing switch (not shown) of the electronic key is operated in the open state shown in FIGS. 15A and 15B, the motor 41 rotates backward. As a result, the drive gear 42 rotates in the direction Ra2, the first gear 43 starts to rotate in the direction Rb2, and the second gear 44 starts to rotate in the direction Rc2.

As shown in FIG. 16B, when the first gear 43 rotates, the convex portion 51 of the differential mechanism 50 rotates integrally, and the convex portion 51 moves from the direction Rb1 side to the direction Rb2 side in the concave portion 52. During this time, since the convex portion 51 merely moves in the gap 53 and does not press the opposing surface of the concave portion 52, the pivot portion 31a of the arm 30 does not rotate. As shown in FIG. 16A, when the second gear 44 rotates, the cam 45 also rotates integrally, but the lock member 35 is held at the unlock position by the holding portion 45b.

Next, as shown in FIG. 17B, the pressing of the facing surface of the concave portion 52 by the convex portion 51 is started by the rotation of the first gear 43, and the arm 30 at the advanced position starts to rotate toward the retracted position. Thus, the lid 25 at the open position starts to rotate toward the closed position. As shown in FIG. 17A, the cam follower 35c of the lock member 35 is located in the formation region of the inclined portion 45a from the holding portion 45b of the cam 45 by the rotation of the second gear 44. However, in this state, since the lock portion 35a abuts on the recessed groove 32c, the cam follower 35c does not abut on the inclined portion 45a, and movement of the lock member 35 to the lock position is prevented.

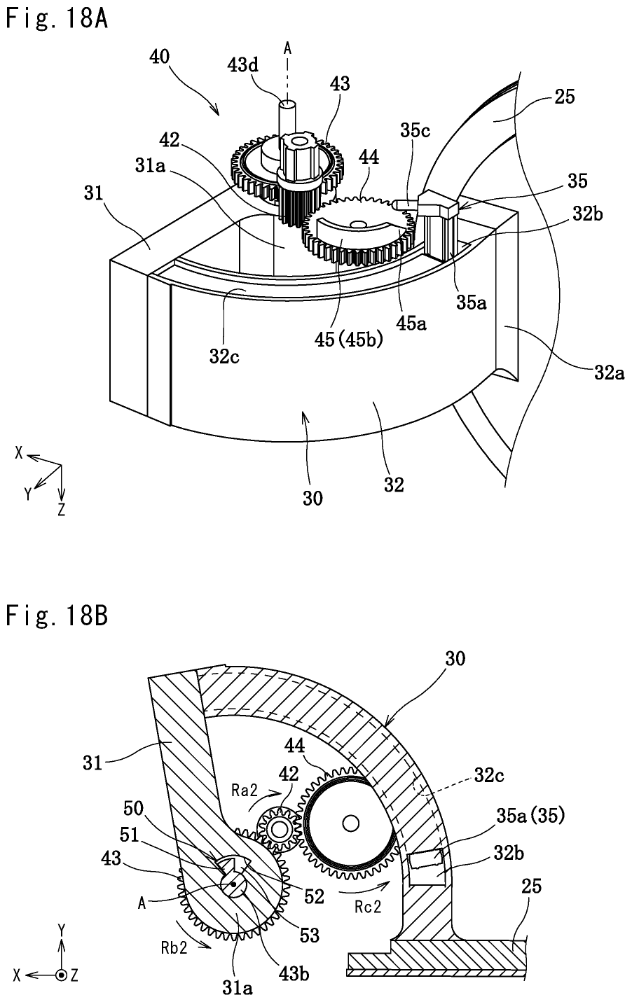

Subsequently, as shown in FIGS. 18A and 18B, when the arm 30 rotates to the retracted position via the differential mechanism 50 by the rotation of the first gear 43, the lock hole 32b is located immediately above the lock member 35, and the motor 41 stops. As a result, as shown in FIGS. 9 and 10, the lock member 35 is moved to the lock position by the biasing force of the spring 36 (see FIG. 6), and the lock portion 35a engages with the lock hole 32b. As shown in FIG. 3, the lid 25 rotates to the closed position, and closes the opening portion 3 to cover the power supply connector 15.

The lid opening and closing device 10 configured as described above has the following features.

Since the first gear 43 that rotates the pivot portion 31a of the arm 30 by receiving the drive force of the motor 41 is provided, the lid 25 can be reliably and automatically opened and closed via the arm 30. In addition, the second gear 44 that rotates in conjunction with the first gear 43 and the lock member 35 movable by the cam 45 of the second gear 44 are provided, and the lock member 35 engages with the lock hole 32b of the arm 30 when the arm 30 rotates to the retracted position, so that the lid 25 can be reliably locked via the arm 30. As described above, since the automatic opening and closing of the lid 25 and the locking of the lid 25 by the lock member 35 can be realized by one motor 41, security can be improved while suppressing an increase in size and cost of the lid opening and closing device 10 as compared with the case of mounting two drive sources.

When the lock member 35 at the lock position is moved to the unlock position by the cam 45, the differential mechanism 50 starts the rotation of the pivot portion 31a. Specifically, the differential mechanism 50 has the convex portion 51 provided on one of the pivot portion 31a and the first gear 43 and the concave portion 52 provided on the other, and has the gap 53 of the determined differential angular range α between the convex portion 51 and the concave portion 52 in the circumferential direction. Therefore, the automatic opening and closing and the locking of the lid 25 can be realized by one motor 41 without hindering the movement of the arm 30 (opening and closing of the lid 25) by the lock member 35.

The arm 30 includes the first arm portion 31 including the pivot portion 31a and the second arm portion 32 including the connecting portion 32a, the lock hole 32b is provided in the second arm portion 32, the first gear 43 is arranged on the pivot portion 31a side, and the second gear 44 is arranged between the first gear 43 and the second arm portion 32. That is, the lock hole 32b is provided in the second arm portion 32 away from the pivot portion 31a which is the rotation center and close to the lid 25. Therefore, as compared with the case where the lock hole 32b is provided in the vicinity of the pivot portion 31a, the load applied to the lock member 35 when the lid 25 in the closed state is illegally operated can be reduced, and the lid 25 can be reliably positioned at the opening portion 3.

The drive gear 42 attached to the motor 41 is arranged between the first gear 43 and the second gear 44. Therefore, even when the lock hole 32b is provided at a position away from the pivot portion 31a, the second gear 44 having the cam 45 can be arranged near the lock hole 32b. In other words, since the lock hole 32b can be arranged at a position away from the pivot portion 31a, the load of the lock member 35 when the lid 25 is illegally operated can be effectively reduced.

Note that the present invention is not limited to the configuration of the above embodiment, and various modifications can be made.

For example, the lid 25 (arm 30) may be rotatable in the vertical direction about a rotation axis extending in the vehicle length direction X.

The differential mechanism 50 can be changed as necessary as long as it has a configuration (structure) capable of starting the rotation of the pivot portion 31a (arm 30) after moving the lock member 35 at the lock position to the unlock position.

The second arm portion 32 may be integrally molded with the lid 25 or may be integrally molded with the first arm portion 31.

The first gear 43 may be arranged at a portion different from the pivot portion 31a, and may be configured to rotate by a drive force transmitted by a known transmission structure.

The second gear 44 may be arranged on the side opposite to the first gear 43 (the attachment portion 22 side) with respect to the arm 30.

The first gear 43 and the second gear 44 may be directly meshed without using the drive gear 42, and the motor 41 may be attached to one of the first gear 43 and the second gear 44. The drive mechanism 40 may include four or more gears.

The lock hole 32b may be provided on the radially inner side or the radially outer side of the second arm portion 32, and the locking and unlocking of the arm 30 may be switched by moving the lock member 35 in the radial direction of the second arm portion 32 by the cam.

### REFERENCE SIGNS LIST

1 side panel (panel)

2 concave portion

3 opening portion

4 attachment port

10 lid opening and closing device

15 power supply connector (receiving portion)

15a connecting portion

20 base

21 base body

21a insertion through hole

21b window through hole

21c concave portion

22 attachment portion

22a concave portion

22b attachment port

23 seal member

24 bearing portion

24a end plate

24b coupling plate

24c shaft hole

24d through hole

24e shaft portion

24f shaft portion

24g insertion through hole

24h stopper portion

25 lid

25a convex portion

30 arm

31 first arm portion

31a pivot portion

31b shaft through hole

32 second arm portion

32a connecting portion (distal end portion)

32b lock hole (engaging portion)

32c recessed groove

35 lock member

35a lock portion

35b head portion

35c cam follower

36 spring

40 drive mechanism

41 motor (drive source)

42 drive gear

43 first gear

43a protruding portion

43b shaft portion

43c protruding portion

43d shaft portion

44 second gear

44a shaft through hole

45 cam

45a inclined portion

45b holding portion

50 differential mechanism

51 convex portion

52 concave portion

53 gap

A rotation axis

r1 angular range of convex portion

r2 angular range of concave portion

α differential angular range

β angular range for forming inclined portion

γ delay angular range

1. A lid opening and closing device comprising:
a base including a bearing portion and arranged inside an opening portion of a panel;
a receiving portion attached to the base so as to be located in the opening portion;
a lid that openably closes the opening portion;
an arm including a pivot portion on one end side pivotally supported by the bearing portion and a distal end portion on the other end side connected to the lid, the arm being movable between a retracted position where the arm is retracted into the panel and the opening portion is closed by the lid, and an advanced position where the arm is protruded to an outside of the panel and the opening portion is opened;
a first gear that transmits a drive force received from a drive source to the pivot portion to rotate the pivot portion;
a second gear that includes a cam and rotates in conjunction with the first gear;
a lock member that is movable between a lock position and an unlock position by the cam when the arm is at the retracted position;
an engaging portion provided on the arm and capable of engaging with the lock member when the arm is at the retracted position; and
a differential mechanism provided in the pivot portion and the first gear, the differential mechanism being configured to start rotation of the pivot portion with a delay with respect to start of rotation of the first gear when the arm at the retracted position is moved to the advanced position.

2. The lid opening and closing device according to claim 1, wherein, when the lock member at the lock position is moved to the unlock position by the cam, the differential mechanism starts rotation of the pivot portion.

3. The lid opening and closing device according to claim 1,
wherein the differential mechanism includes:
a convex portion provided on one of the pivot portion and the first gear; and
a concave portion provided in the other of the pivot portion and the first gear, the concave portion having the convex portion arranged therein,
wherein an angular range of the convex portion around a rotation axis of the pivot portion is smaller than an angular range of the concave portion around the rotation axis, and
wherein a gap of a predetermined differential angular range is provided between the convex portion and the concave portion in a circumferential direction around the rotation axis.

4. The lid opening and closing device according to claim 1,
wherein the arm includes:
a first arm portion having a plate shape that includes the pivot portion and protrudes from the pivot portion; and
a second arm portion that includes the distal end portion, has an arc shape around the rotation axis of the pivot portion, and is continuous with a distal end of the first arm portion,
wherein the engaging portion is provided in the second arm portion,
wherein the first gear is arranged coaxially with the pivot portion, and
wherein the second gear is arranged between the first gear and the second arm portion.

5. The lid opening and closing device according to claim 1, wherein a drive gear directly rotated by the drive source and meshed with the first gear and the second gear is arranged between the first gear and the second gear.

6. The lid opening and closing device according to claim 2,
wherein the differential mechanism includes:
a convex portion provided on one of the pivot portion and the first gear; and
a concave portion provided in the other of the pivot portion and the first gear, the concave portion having the convex portion arranged therein,
wherein an angular range of the convex portion around a rotation axis of the pivot portion is smaller than an angular range of the concave portion around the rotation axis, and
wherein a gap of a predetermined differential angular range is provided between the convex portion and the concave portion in a circumferential direction around the rotation axis.

7. The lid opening and closing device according to claim 2,
wherein the arm includes:
a first arm portion having a plate shape that includes the pivot portion and protrudes from the pivot portion; and
a second arm portion that includes the distal end portion, has an arc shape around the rotation axis of the pivot portion, and is continuous with a distal end of the first arm portion,
wherein the engaging portion is provided in the second arm portion,
wherein the first gear is arranged coaxially with the pivot portion, and
wherein the second gear is arranged between the first gear and the second arm portion.

8. The lid opening and closing device according to claim 3,
wherein the arm includes:
a first arm portion having a plate shape that includes the pivot portion and protrudes from the pivot portion; and
a second arm portion that includes the distal end portion, has an arc shape around the rotation axis of the pivot portion, and is continuous with a distal end of the first arm portion,
wherein the engaging portion is provided in the second arm portion,
wherein the first gear is arranged coaxially with the pivot portion, and
wherein the second gear is arranged between the first gear and the second arm portion.

9. The lid opening and closing device according to claim 6,
wherein the arm includes:
a first arm portion having a plate shape that includes the pivot portion and protrudes from the pivot portion; and
a second arm portion that includes the distal end portion, has an arc shape around the rotation axis of the pivot portion, and is continuous with a distal end of the first arm portion,
wherein the engaging portion is provided in the second arm portion,
wherein the first gear is arranged coaxially with the pivot portion, and
wherein the second gear is arranged between the first gear and the second arm portion.

10. The lid opening and closing device according to claim 2, wherein a drive gear directly rotated by the drive source and meshed with the first gear and the second gear is arranged between the first gear and the second gear.

11. The lid opening and closing device according to claim 3, wherein a drive gear directly rotated by the drive source and meshed with the first gear and the second gear is arranged between the first gear and the second gear.

12. The lid opening and closing device according to claim 4, wherein a drive gear directly rotated by the drive source and meshed with the first gear and the second gear is arranged between the first gear and the second gear.

13. The lid opening and closing device according to claim 6, wherein a drive gear directly rotated by the drive source and meshed with the first gear and the second gear is arranged between the first gear and the second gear.

14. The lid opening and closing device according to claim 7, wherein a drive gear directly rotated by the drive source and meshed with the first gear and the second gear is arranged between the first gear and the second gear.

15. The lid opening and closing device according to claim 8, wherein a drive gear directly rotated by the drive source and meshed with the first gear and the second gear is arranged between the first gear and the second gear.

16. The lid opening and closing device according to claim 9, wherein a drive gear directly rotated by the drive source and meshed with the first gear and the second gear is arranged between the first gear and the second gear.
